(19) United States
(12) Patent Application Publication
(10) Pub. No.: US 2011/0120641 A1
(43) Pub. Date: May 26, 2011

(54) ADHESIVE TAPE JOINING APPARATUS AND ADHESIVE TAPE JOINING METHOD

(76) Inventors: Masayuki Yamamoto, Osaka (JP); Chouhei Okuno, Osaka (JP)

(21) Appl. No.: 12/911,813

(22) Filed: Oct. 26, 2010

(30) Foreign Application Priority Data
Nov. 20, 2009 (JP) 2009-265116

(51) Int. Cl. B29C 65/00; B32B 38/04

(52) U.S. Cl. 156/285; 156/510

(57) ABSTRACT

Upper and lower housings nip a supporting adhesive tape that is exposed between an outer periphery of a wafer and a ring frame, thereby forming a chamber. Here, the adhesive tape having a larger width than a diameter of the ring frame divides the chamber into the upper and lower housings to form two spaces. Pressure difference occurs between both spaces such that the lower housing has a reduced pressure than the upper housing for joining the adhesive tape to the wafer.

### BACKGROUND OF THE INVENTION

1. Field of the Invention

This invention relates to adhesive tape joining method and apparatus to join a supporting adhesive tape over a rear face of a ring frame and a rear face of a semiconductor wafer placed in a center of the ring frame for integrating the semiconductor wafer with the ring frame via the adhesive tape.

2. Description of the Related Art

Typically, a circuit pattern with numerous components is formed on a surface of a semiconductor wafer (hereinafter simply referred to as a “wafer”), and then a protective tape is joined to the surface of the wafer for protection. Grinding or polishing is performed in a back grinding process to a rear face of the wafer having the protected surface, thereby obtaining a desired thickness of the wafer. The thinned wafer has reduced rigidity, and thus joined to and held on a ring frame via the supporting adhesive tape. Thus, a mount frame is to be manufactured.

A method has been proposed of bonding an adhesive tape to a rear face of a wafer to avoid scattering of cut chips from the wafer in a dicing process upon joining of the supporting adhesive tape to the wafer. Specifically, a joining roller rolls with the wafer and a ring frame housed in a chamber under a reduced pressure, thereby joining the adhesive tape over rear faces of the ring frame and the wafer. See Patent Publication No. 2008-066684.

The foregoing conventional method, however, has the following problem. That is, in the conventional apparatus, all mechanisms including the wafer, the ring frame, and the joining roller have to be housed in the chamber, which leads to larger apparatus in size. Accordingly, inconvenience may occur that it takes more time to reduce pressure as the chamber has a larger volume, thereby taking a longer total processing time.

### SUMMARY OF THE INVENTION

This invention has one object to provide apparatus and method of joining an adhesive tape that allows miniaturization of the apparatus for an enhanced processing speed as well as accurate joining of the adhesive tape over the semiconductor wafer and the ring frame.

This invention also discloses adhesive tape joining apparatus to adhesively hold a semiconductor on a ring frame via a supporting adhesive tape. The apparatus includes a holding table; a frame holder; a tape joining mechanism; a tape cutting mechanism; a chamber; and a tape joining mechanism. The holding table holds the semiconductor wafer placed thereon with a pattern surface thereof directed downward. The frame holder holds the ring frame placed thereon. The tape joining mechanism joins the adhesive tape to the ring frame. The tape cutting mechanism cuts the adhesive tape along a contour of the ring frame. The chamber is composed of a pair of housings that nips at least the adhesive tape between an outer periphery of the semiconductor wafer and the ring frame for housing the semiconductor wafer. The tape joining mechanism joins the adhesive tape to the rear face of the semiconductor wafer in the chamber under a reduced pressure.

With this apparatus, the chamber is formed with a pair of upper and lower housings that nips an adhesive surface of the adhesive tape exposed between the outer periphery of the semiconductor wafer and the ring frame. That is, the chamber is formed in which the adhesive tape functions as a seal material and divides an inside thereof into two spaces. Consequently, it is not necessary to house the ring frame entirely into the chamber. Thus, the apparatus having this configuration is smaller in size than the conventional apparatus having the configuration in which the entire of the ring frame is housed into the chamber. The miniaturization of the apparatus results in a chamber of a smaller volume, which realizes readily and rapid control of atmospheric pressure in the chamber.

For instance, the tape joining mechanism may be configured as follows.

The tape joining mechanism functions as an inner pressure controller that controls atmospheric pressure in the chamber. The inner pressure controller preferably controls inner pressure in one housing with the semiconductor wafer housed therein as to be lower than that in the other housing for joining the adhesive tape to the semiconductor wafer. Here, both housings are divided with the adhesive tape interposed therebetween.

This configuration has no need for utilizing the joining roller. That is, the adhesive tape may be joined to the rear face of the semiconductor wafer with higher accuracy merely by controlling atmospheric pressure in the divided housings. Accordingly, the apparatus may be smaller in size than the conventional apparatus.

Moreover, it is preferable to join the adhesive tape to the rear face of the semiconductor wafer with the inner pressure controller, and thereafter, make the atmospheric pressure equal in both divided housings and open the housings to the atmosphere simultaneously.

This configuration effectively functions when both divided housings have different volumes. Specifically, when both housings are open to have atmospheric pressure while the semiconductor wafer has the adhesive tape joined thereto with pressure difference in both housings, the adhesive tape having the exposed adhesive surface between the outer periphery of the wafer and an inner diameter of the ring frame is drawn toward a side with low atmospheric pressure. In particular, this phenomenon occurs from a tendency that a speed of returning to atmospheric pressure is slightly slower in a larger volume than in a smaller volume. In other words, this phenomenon may cause unnecessary extension in the adhesive tape.

With the configuration of this embodiment, however, both housings are made to have equal atmospheric pressure and are open to the atmosphere simultaneously, which results in suppression of extension in the adhesive tape.

Moreover, a joining member is preferably provided that joins the adhesive tape to the semiconductor wafer while moving about a central axis of the semiconductor wafer from a center to the outer periphery of the semiconductor wafer, and vice versa.

With this configuration, the joining member may move on the adhesive tape while pressing with no pressure difference in both sealed housings that have the same reduced atmospheric pressure. Here, the joining member moves about the center axis of the wafer. Accordingly, the configuration of this embodiment may be smaller in size as compared with the conventional configuration in which a joining roller having a longer diameter than a semiconductor wafer that rolls throughout the wafer. The configuration of this embodiment effectively functions in joining of the adhesive tape to the semiconductor wafer having an annular projection formed on the rear face thereof.

Moreover, the joining member is preferably a pressing member that presses an entire surface of the semiconductor wafer while being elastically deformed radially from the center thereof.

With this configuration, the joining member may join the adhesive tape to the semiconductor wafer with higher accuracy while pressing against the adhesive tape with no pressure difference in both sealed housings that have the same reduced atmospheric pressure.

This invention also discloses an adhesive tape joining method of adhesively holding a semiconductor on a ring frame via a supporting adhesive tape. The method includes the steps of forming a chamber by nipping at least an adhesive tape between an outer periphery of the semiconductor wafer and the ring frame with a pair of housings; and joining the adhesive tape to a rear face of the semiconductor wafer with the chamber under a reduced pressure.

According to this method, only the adhesive tape that is exposed between the outer periphery of the semiconductor wafer and the ring frame is nipped with a pair of housings, thereby forming the chamber. That is, the chamber is formed in which the adhesive tape functions as a seal material and divides an inside thereof into two spaces. Here, the semiconductor wafer is housed in the chamber.

Consequently, it is not necessary to house the ring frame entirely into the chamber. The space with only the semiconductor wafer housed therein has a reduced pressure, thereby joining the adhesive tape to the semiconductor wafer. Thus, the apparatus having this configuration is smaller in size than the conventional apparatus having the configuration in which the entire of the ring frame is housed into the chamber. The miniaturization of the apparatus results in a chamber of a smaller volume, which realizes readily and rapid control of atmospheric pressure in the chamber.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a front elevation view showing a general configuration of an adhesive tape joining apparatus.

FIG. 2 is a side view of a tape joining section.

FIG. 3 is a sectional view showing a main portion of a chamber.

FIG. 4 is a plan view showing a tape cutting mechanism.

FIGS. 5 to 9 are front elevation views each showing operation of the apparatus according to this embodiment.

FIG. 10 is a perspective view of a wafer mounting device.

FIG. 11 is a sectional view showing a main portion of a tape joining section according to one modification.

FIG. 12 is a partial cut-away perspective view of a semiconductor wafer used in the modification.

FIG. 13 is a perspective view of a rear face of the semiconductor wafer used in the modification.

FIG. 14 is a longitudinal sectional view of the semiconductor wafer used in the modification.

FIG. 15 is a sectional view showing a main portion of a tape joining section according to another modification.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One exemplary embodiment of this invention will be described in detail hereinafter with reference to the drawings.

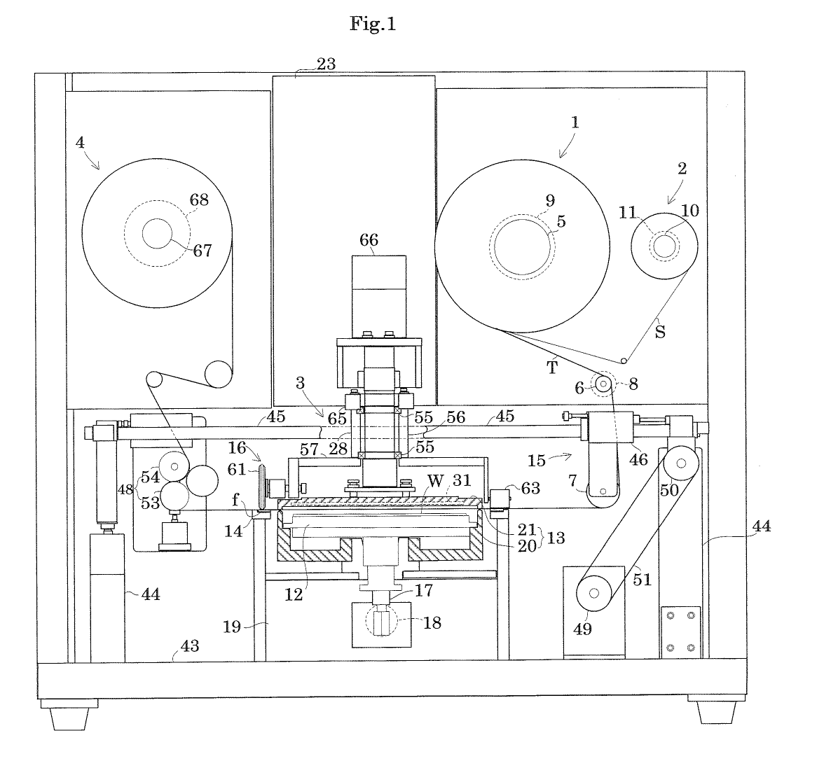

As shown in FIG. 1, adhesive tape joining apparatus has a tape supply section 1, a separator collecting section 2, a tape joining section 3, and a tape collecting section 4. Description will be given hereinafter of each element in detail.

As shown in FIG. 1, the tape supply section 1 winds up a supporting adhesive tape T to a feed roller 6, and guides the adhesive tape T toward a joining roller 7. Here, a separator S provided with the adhesive tape T is separated therefrom.

A motor 8 rotates the feed roller 6.

The supply bobbin 5 is interlocked and coupled with an electromagnetic brake 9, and subjected to appropriate rotational resistance, which results in prevention of the adhesive tape from being fed out excessively.

The separator collecting section 2 has a collection bobbin 10 that winds up the separator S separated from the adhesive tape T. A motor 11 controls forward and backward rotation of the collection bobbin 10.

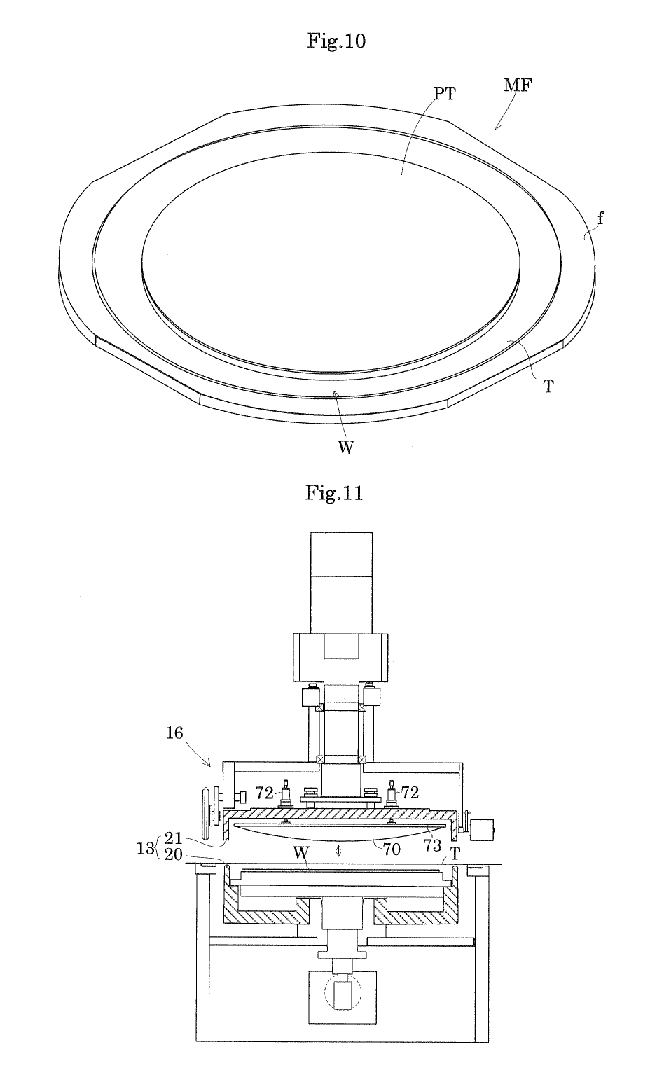

The tape joining section 3 has a holding table 12, a chamber 13, a frame holder 14, a tape joining mechanism 15, and tape cutting mechanism 16. The holding table 12 holds a semiconductor wafer W (hereinafter simply referred to as a “wafer W”) placed thereon such that a pattern surface thereof having a protective tape PT (see FIG. 10) joined thereto is directed downward. The chamber 13 houses the holding table 12. The frame holder 14 holds the ring frame f placed thereon. The tape joining mechanism 15 joins the adhesive tape to the ring frame f that is placed on the frame holder 14. The tape cutting mechanism 16 cuts the adhesive tape T joined to the ring frame f along a contour of the ring frame f.

The holding table 12 is connected to one end of a rod 17 that penetrates through a lower housing 20. The lower housing 20 constitutes the chamber 13. The other end of the rod 17 is drivably connected to a motor 18. Accordingly, the holding table 12 moves vertically within the lower housing 20 through forward and backward rotation of the motor 18. Here, the motor 18 is provided in a base 19.

The chamber 13 is formed of a pair of upper and lower housings having a diameter smaller than a width of the adhesive tape T. The lower housing 20 is fixedly connected to the base 19. The cylindrical lower housing 20 has a rounded portion on a top thereof. A releasing treatment, such as fluorine treatment is performed to the rounded portion.

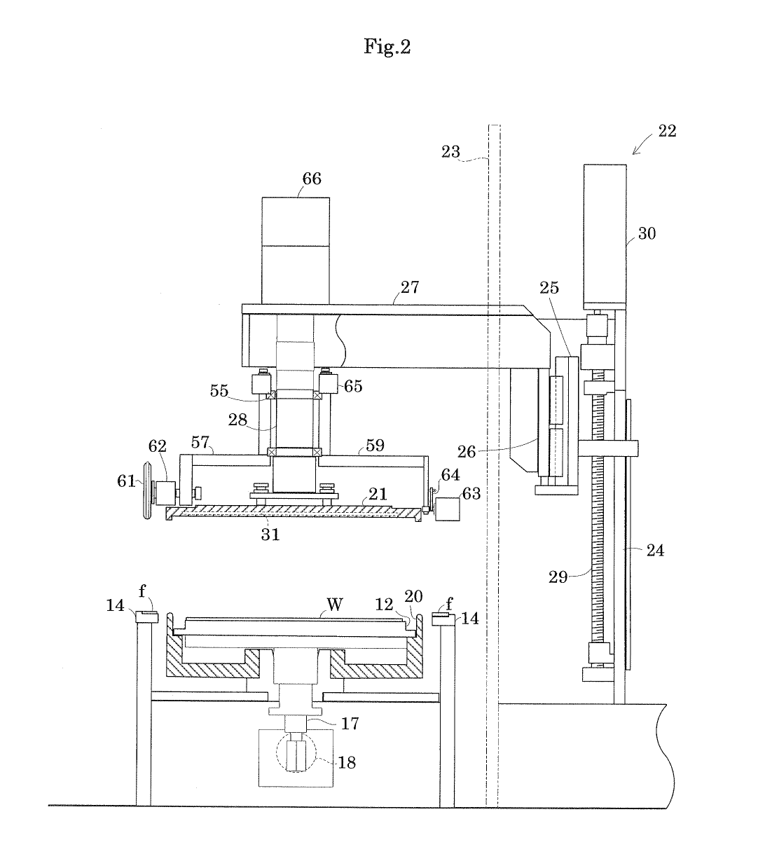

As shown in FIG. 2, the upper housing 21 is provided in a lifting mechanism 22. The lifting mechanism 22 has a movable table 25, a movable frame 26, and an arm 27. The movable table 25 may move upward and downward along a rail 24 arranged vertically at a backside of a wall 23. The movable frame 26 is supported on the movable table 22 so as to control a level thereof. The arm 27 extends forward from the movable frame 26. The upper housing 21 is attached on a pivot 28 that extends downward from a front end of the arm 27. The upper housing 21 has at its upper portion a heater 31 embedded therein.

The movable table 25 moves upward and downward in a screw feed manner by forward and backward rotation of a screw shaft 29 by a motor 30.

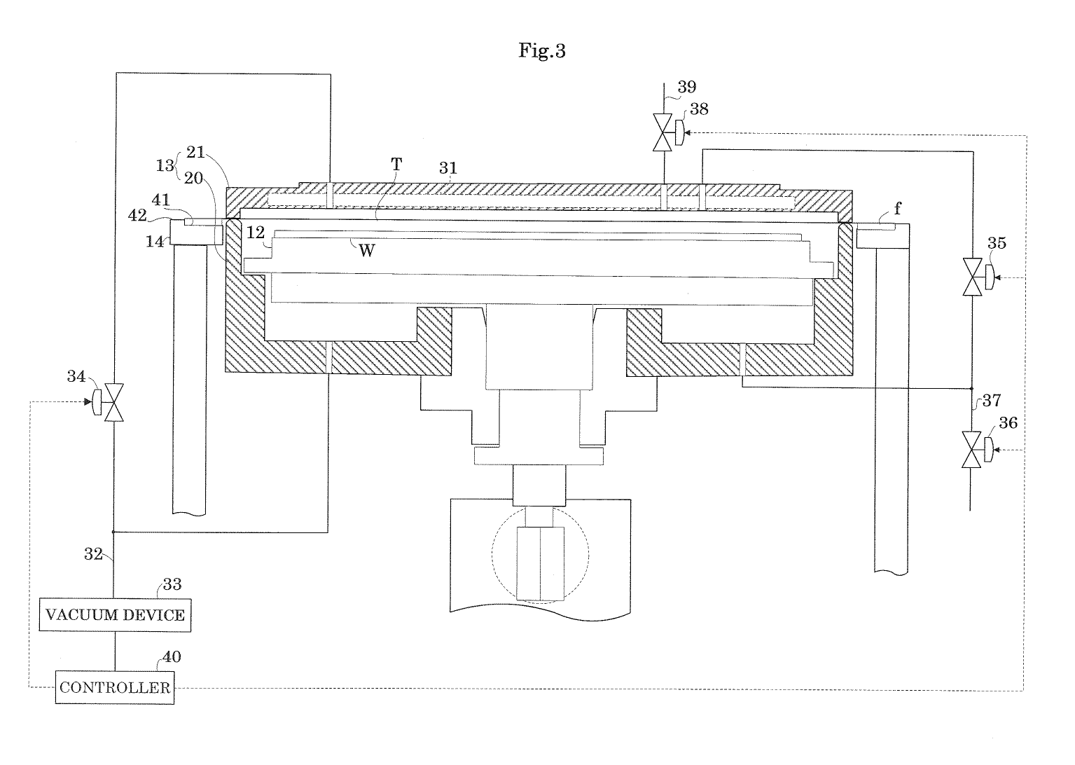

As shown in FIG. 3, both housings 20 and 21 are in communication with a vacuum device 33 via a channel 32. Moreover, the channel 32 has a magnetic valve 34 on a side of the upper housing 21. Both housings 20 and 21 are in communication with a channel 37 having magnetic valves 35 and 36 for air release. The upper housing 21 is also in communication with a channel 39 having a magnetic valve 38 for adjusting an inner pressure with leak that has been reduced temporarily. A controller 40 performs switching of the magnetic valves 34, 35, 36, and 38, and operation of the vacuum devices 33. The controller 40 corresponds to the inner pressure controller of this invention.

The frame holder 14 has an annular shape that is erected from the base 19 so as to enclose the chamber 13. The frame holder 14 has a step 41 formed at a top thereof for receiving the ring frame f. The step 41 is configured such that the surface of the ring frame f is flush with a surface of a projection 42 on an outer periphery of the frame holder 14 when receiving the ring frame f.

Now referring to FIG. 1, the tape joining mechanism 15 has a guide rail 45, a joining roller 7, and a nip roller 48. The guide rail 45 is built over a pair of support frames 44 on the apparatus base 43 across the holding table 12. The joining roller 7 is provided in a movable table 46 that moves horizontally along the guide rail 45. The nip roller 48 is fixedly provided on a side of the tape collecting section 4.

The movable table 46 reciprocates horizontally along the guide rail 45. That is, a driving force is transmitted to the movable table 46 via a belt 51 that is wound between a drive pulley 49 and an idler pulley 20. The drive pulley 49 is pivotably supported on a drive that is fixedly arranged on the apparatus base 43 so as to rotate forward and backward. The idler pulley 50 is pivotably supported on a side of the support frame 44.

The nip roller 48 is formed of a feed roller 53 and a pinch roller 54. A motor drives the feed roller 53. A cylinder moves the pinch roller 54 vertically.

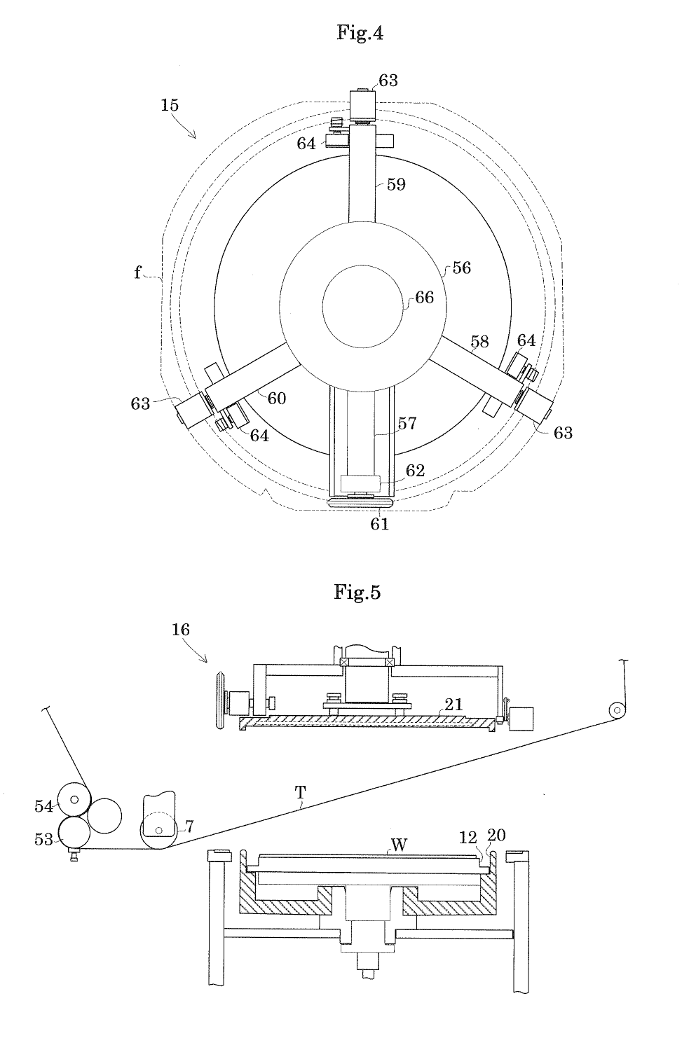

The tape cutting mechanism 16 is provided in the lifting mechanism 22 that lifts the upper housing 21. Specifically, a boss 56 is provided that rotates about the pivot 28 via a bearing 55 shown in FIG. 1. The boss 56 has four support arms 57 to 60 that extend radially from a center thereof, as shown in FIG. 4.

As shown in FIGS. 2 and 4, the support arm 57 has at one end a cutter bracket 62 attached thereon. The cutter bracket 62 horizontally supports a disk cutter 61 and moves vertically. Moreover, each of the support arms 58 to 60 has at one end a pressing roller 63 attached thereon via a swing arm 64 so as to move vertically.

The boss 56 has a connecting portion 65 on a top thereof. The connecting portion 65 is drivably connected to a rotational axis of a motor 66 provided in the arm 27.

Returning to FIG. 1, the tape collecting section 4 has a collection bobbin 67 that winds up the separator S separated from the adhesive tape T. A motor 68 controls forward and backward rotation of the collecting bobbin 67.

Description will be next given of a round of operation for joining the adhesive tape T to the ring frame f and the wafer W with the apparatus according to the foregoing embodiment.

A transport device, such as a transfer robot not shown moves and places the wafer W on the holding table 12. Here, the holding table 12 moves upward to a level where the holding surface thereof is higher than the top of the lower housing 20. The wafer W is placed on the holding table 12, and then the holding table 12 moves downward to a level where the surface of the wafer W on the holding table 12 is slightly lower than the top of the lower housing 20.

Upon completion of the placement of the wafer W on the holding table 12, the ring frame f is moved and placed on the frame holder 14. As shown in FIG. 5, herein, the joining unit 7 is in a standby position on the side of the tape collecting section 4. Then, the pinch roller 54 moves downward to nip the adhesive tape T with the feed roller 53.

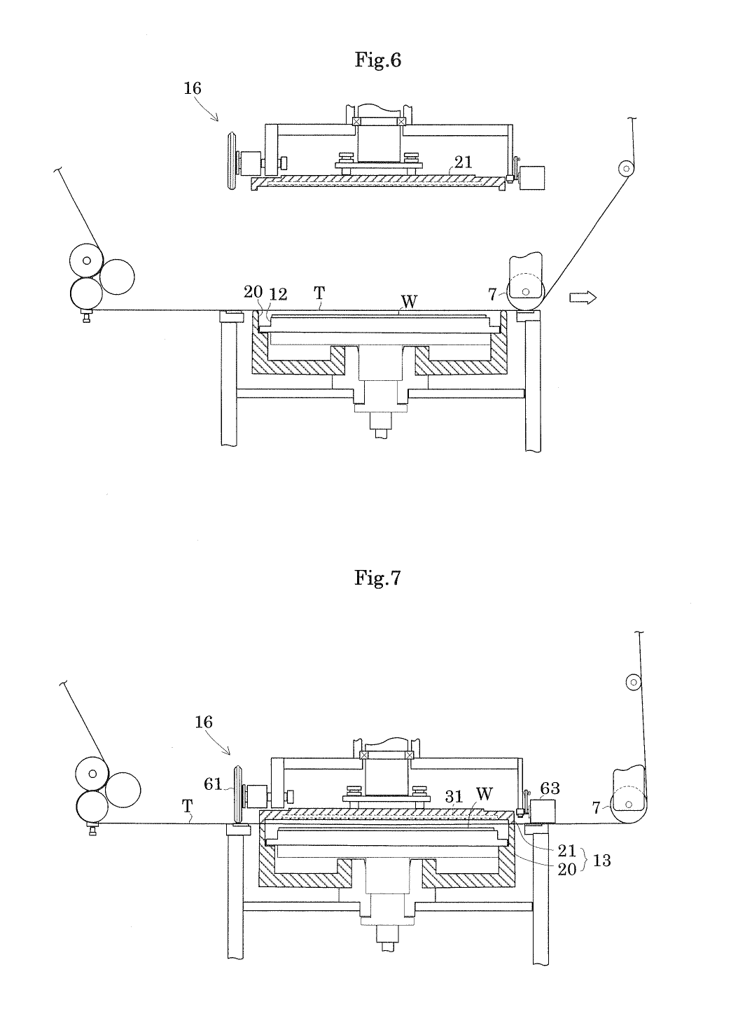

As shown in FIG. 6, the joining roller 7 joins the adhesive tape T to the ring frame f while moving to the right along the guide rail 45. The adhesive tape T is fed out by a given length from the tape supply section 1 in response to movement of the joining roller 7 while the separator S is separated therefrom.

Upon completion of joining of the adhesive tape T to the ring frame f, the upper housing 21 moves downward as shown in FIG. 7. In response to the downward movement, the upper housing 21 and the lower housing 20 nip the adhesive tape T having the adhesive face thereof exposed between the outer periphery of the wafer W and the inner diameter of the ring frame f, whereby the chamber 13 is formed. Here, the adhesive tape functions as a seal material and divides an inside of the chamber into the upper housing 21 and the lower housing 20 to form two spaces.

The wafer W in the lower housing 20 has given clearance to the adhesive tape T.

The controller 40 operates the heater 31 to heat the adhesive tape T from the side of the upper housing 21. The vacuum device 33 operates with the magnetic valves 35, 36, and 38 closed to reduce pressure in the upper housing 21 and the lower housing 20. Here, opening of the magnetic valve 34 is adjusted such that both housings 20 and 21 have the same speed of reducing pressure therein.

When the pressure in both housings 20 and 21 is reduced to given atmospheric pressure, the controller 40 closes the magnetic valve 34 and suspends operation of the vacuum devices 33.

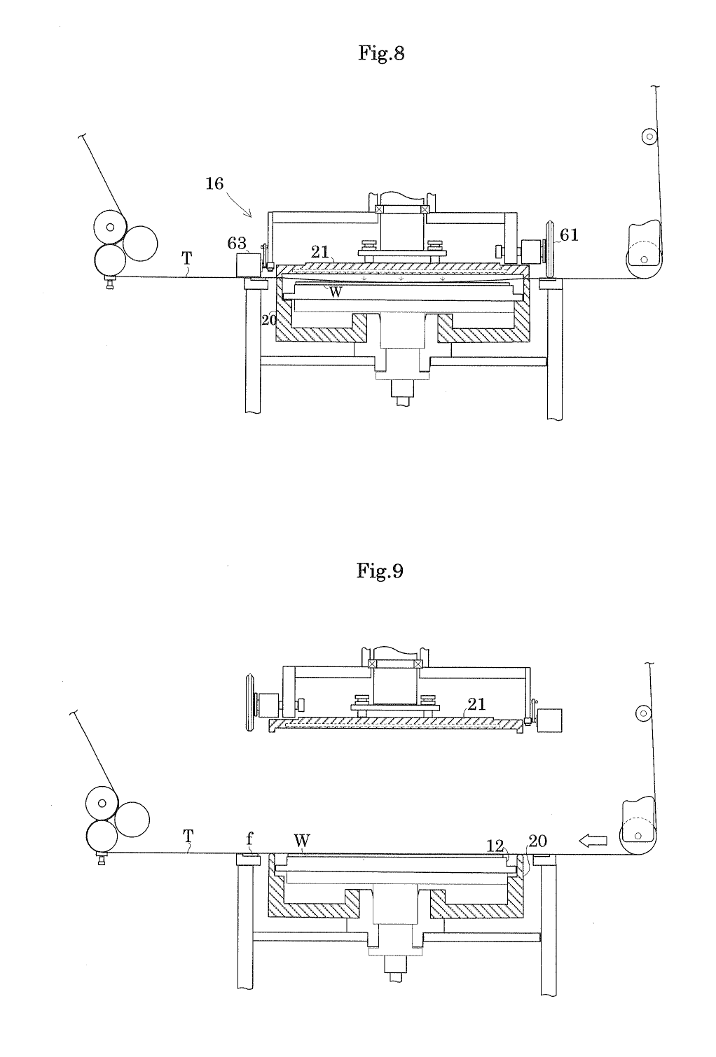

The controller 40 gradually increase the pressure in the upper housing 21 to given atmospheric pressure while adjusting the opening of the magnetic valve 34 with leaking. Here, the lower housing 20 has atmospheric pressure lower than the upper housing 21. As shown in FIG. 8, the adhesive tape T is drawn into the lower housing 20 from the center thereof due to the pressure difference, and is gradually joined to the wafer W arranged closely from the center towards the outer periphery thereof.

The pressure in the upper housing 21 reaches the atmospheric pressure set in advance, and then the controller 40 adjusts the opening of the magnetic valve 36 to make the atmospheric pressure in the upper housing 21 equal to that in the lower housing 20. In response to the adjustment of the atmospheric pressure, the holding table 12 is moved upward such that the surface of the ring frame f is flush with the top face of the wafer W. Thereafter, as shown in FIG. 9, the controller 40 moves the upper housing 21 upward to open it to the atmosphere. The controller 40 also opens the magnetic valve 36 completely to open the lower housing 20 to the atmosphere.

The tape cutting mechanism 16 operates while the adhesive tape T is joined to the wafer W in the chamber 13. Here, the cutter 61 cuts the adhesive tape T joined to the ring frame f along a contour of the ring frame f, and the pressing roller 63 follows the cutter 61 to press against a cut portion of the tape on the ring frame f while rolling thereon. In other words, when the upper housing 21 moves downward to form the chamber 13 with the lower housing 20, the cutter 61 and the pressing roller 63 in the tape cutting mechanism 16 have already reached a cutting operation position, as shown in FIG. 7.

When the upper housing 21 move upward, completed are processes of joining the adhesive tape T to the wafer W and cutting the adhesive tape T. Accordingly, the pinch roller 54 moves upward to release nipping of the adhesive tape T. Thereafter, the joining roller 7 moves to its initial position on the side of the tape collecting section 4. An unnecessary adhesive tape T after subjected to the cutting process is wound up and collected towards the tape collecting section 4 while the adhesive tape T is fed out by a given length from the tape supply section 1.

Upon returning of the joining roller 7 to its initial position, a transport mechanism not shown transports the wafer W having the ring frame f formed integrally therewith. Here, the wafer W has a planar rear face and a surface with the protective tape PT joined thereto. Thus, a round of operation for joining the adhesive tape T to the wafer W is completed as mentioned above. The similar operation is to be repeated hereinafter.

According to the apparatus of this embodiment, the upper housing 21 and the lower housing 20 nip the adhesive tape T having the adhesive face thereof exposed between the outer periphery of the wafer W and the inner diameter of the ring frame f, whereby the chamber 13 is formed. Consequently, the chamber 13 has a reduced size comparing to the chamber in the conventional apparatus that entirely houses the ring frame f.

The spaces of the divided lower housing 20 and the upper housing 21 are formed via the adhesive tape T, and have difference pressure therebetween, which realizes joining of the adhesive tape T to the wafer W. That is, no drive is needed such as the ring frame f and the joining roller 7 in the chamber as in the conventional apparatus, which results in further smaller apparatus in size.

The miniaturization of the apparatus may result in a chamber 13 of a smaller volume comparing to the conventional apparatus, which realizes rapid reduction and application of atmospheric pressure in the chamber as well as an enhanced processing speed of joining the adhesive tape T.

Moreover, the adhesive tape T may be joined to the wafer W in the chamber 13, and simultaneously may be cut. As a result, the processing speed may further be enhanced.

This invention may be embodied in forms as described below.

In the exemplary embodiment described above, the adhesive tape T is joined to the wafer W with the pressure difference between both spaces of the lower housing 20 and the upper housing 21 divided by the adhesive tape T. Both housings 20 and 21 may be maintained having a same reduced pressure, and the adhesive tape T may be joined to the wafer W while being pressed with the joining member.

As shown in FIG. 11, the joining member may be a pressing member 70 that is formed of an elastic body in an approximately hemisphere shape having a diameter larger than the wafer W.

That is, the pressing member 70 is attached in the upper housing 21 so as to move vertically.

That is, the upper housing 21 has a lifting frame 73 attached therein. The lifting frame 73 slides vertically via four guide shafts, not shown, and lifts with an air cylinder 72. The pressing member 70 is attached to the lifting frame 73.

The pressing member 70 is preferably of a low coefficient of friction and heat-resistant. It is more preferable that the pressing member 70 is made from a material of low hardness. For instance, such as silicon rubber and fluororubber is used to form the pressing member 70 in a hemisphere-shaped block or sheet.

When the pressing member 70 in the hemisphere-shaped block is used as shown in FIG. 11, the block is elastically deformed to gradually join the adhesive tape T to the entire surface of the wafer W while a contact area thereof increases in a radial direction.

When the sheet pressing member is used, it may be made into a shape of a balloon filled with gas or liquid. Alternatively, a partition is formed with the sheet in the upper housing 21 for keeping the atmospheric pressure constant in an upper portion of the upper housing in a state of being opened to the atmosphere.

In addition, when the sheet pressing member is used, pressure difference occurs between upper and lower spaces of the upper housings 21 divided by the sheet due to reduced pressure in the lower space thereof. Consequently, the sheet is elastically deformed and bends downward. As a result, a same phenomenon occurs as when the balloon is used. That is, the sheet is elastically deformed to gradually join the adhesive tape T to the entire surface of the wafer W while the contact area thereof increases in a radial direction.

The foregoing configuration may readily control the inner pressure of the chamber 13. In addition, the adhesive tape T is joined to the wafer W from the center thereof. Consequently, suppression may be made of catching bubbles and occurrence of wrinkles under a reduced pressure.

In the exemplary embodiment described above, the wafer W is described as one example having a planar rear face. The adhesive tape T may also be joined to the wafer W with high accuracy having a reinforcement portion formed by the annular projection at the outer periphery of the rear face thereof.

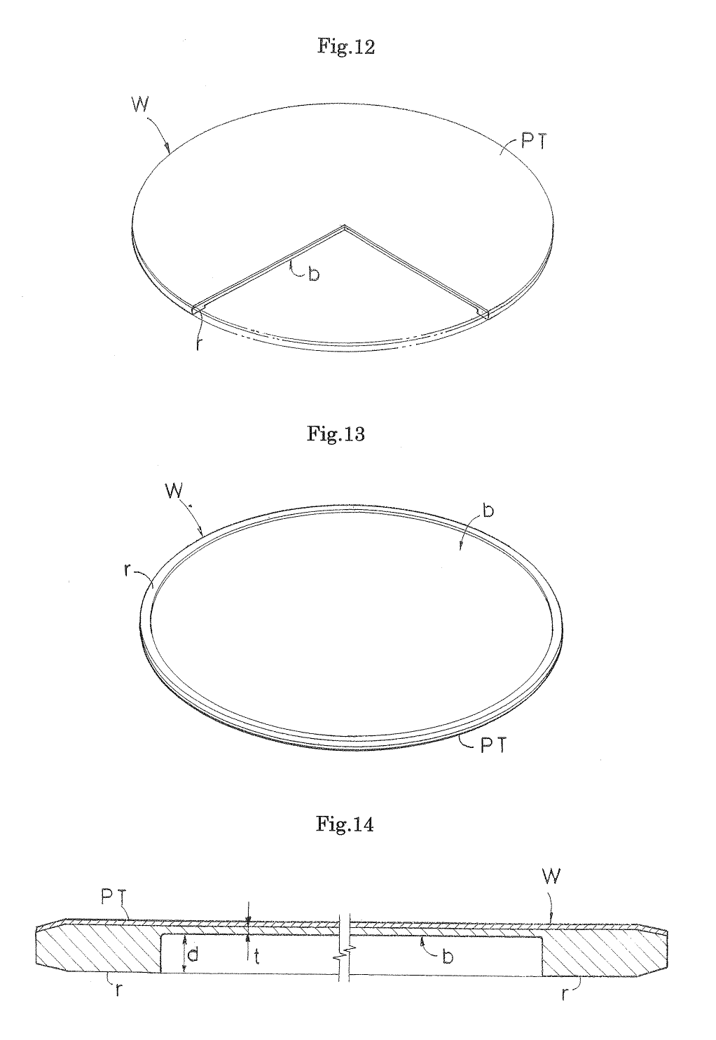

As shown in FIGS. 12 to 14, the wafer W is subjected to a back grinding process with the protective tape PT joined to the surface thereof having a pattern formed thereon for surface protection. The rear face of the wafer W is subject to a grinding process (a back grinding process) except a portion of approximately 2 mm radially from the outer periphery. Accordingly, used is the wafer W having a flat recess b formed on the rear face thereof and an annular projection r remaining along the outer periphery thereof. For instance, the wafer W is processed to have a depth d in the flat recess b of a few hundreds μm and a thickness in a grinding region t of a few tens μm. Consequently, the annular projection r formed at the outer periphery on the rear face of the wafer W functions as an annular rib that enhances rigidity of the wafer W. In addition, the annular projection r may suppress bending deformation of the wafer W during handling or other processes thereof.

Where the adhesive tape T is joined to the rear face using the apparatus according to the exemplary embodiment described above, the adhesive tape T is joined under a reduced pressure while the contact area thereof increases in a radial direction from the center of the wafer W. Consequently, the adhesive tape T is elastically deformable to firmly adhere also from the flat recess b to a corner of the annular projection r.

Alternatively, according to another embodiment of joining the adhesive tape T to the wafer W, a joining member that turns about the center of the wafer W and moves from the center to the outer periphery of the wafer, and vice versa, may join the adhesive tape T to the flat recess b.

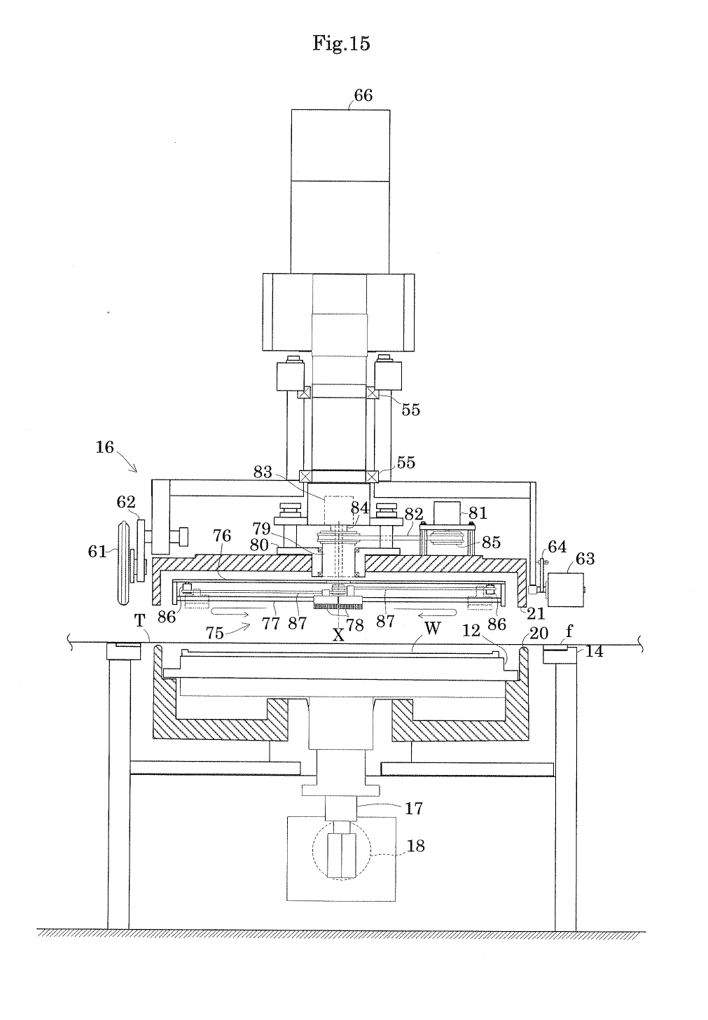

As shown in FIG. 15, a joining mechanism 75 may be provided inside the upper housing 21. The joining mechanism 75 has a turning frame 76, a guide shaft 77, and a pair of joining members 78. The turning frame 76 may turn about a vertical axis X that is coaxial with the center of the upper housing 21. The guide shaft 77 is built horizontally below the turning frame 76. The pair of joining members 78 is supported so as to move horizontally through guidance of the guide shaft 77. Such as a brush that may be moderately deformed elastically is used as the joining member 78.

A cylindrical turning drive shaft 79 is penetrated and supported at the center of the upper housing 21 via a bearing bracket 80 so as to rotate about the vertical axis. In addition, the turning frame 76 is connected to the lower end of the turning drive shaft 79. The idler pulley on the turning driving shaft 79 and a motor 81 placed at one upper side of the upper housing 21 are wound and coupled via a belt 82. The motor 81 operates to turn the turning frame 76 about the vertical axis X.

An inner shaft 84 is penetrated through a center of the turning drive shaft 79. The inner shaft 84 rotates forward and backward by a motor 83 placed above the center of the upper housing 21. A belt 87 is wounded and pulled over a drive pulley having a long length in a vertical direction that is provided on the lower of the inner shaft 84 and a pair of idler pulleys 86 that is pivotably supported near opposite ends of the turning frame 76. That is, a pair of joining members 78 is connected to a position where both belts 87 rotate backward. Accordingly, when the inner shaft 84 rotates in a given direction, the joining members 78 connected to both belts 87 move in a direction opposite to each other or that of approaching to each other.

With this configuration, firm adhering of the adhesive tape T may be realized with higher accuracy to the rear face of the wafer W having the annular projection r formed thereon while the inside of the chamber 13 that is divided into the upper and lower spaces by the adhesive tape T is kept to have the same reduced pressure.

Here, a roller may be utilized instead of the joining member 78.

In the exemplary embodiment described above, the upper housing 21 and the lower housing 20 nip the adhesive tape T having the exposed adhesive surface between the outer periphery of the wafer W and the inner diameter of the ring frame f. The following configuration may be adopted. That is, both housings 20 and 21 may nip the ring frame f. In this configuration, the upper housing 21 and the tape cutting mechanism 16 are provided individually.

In the exemplary embodiment described above, the protective tape PT is joined to the surface with a circuit pattern formed thereon. This embodiment is also applicable to the wafer W to which a support substrate, such as a glass, is joined via a double-faced adhesive tape.

In the exemplary embodiment described above, the housing table 12 may have a heater embedded therein.

In the exemplary embodiment described above, the frame holder 14 may be formed integrally with the lower housing 20.

The exemplary embodiment described above is also applicable to the ring frame f having the adhesive tape T joined thereto that is cut in advance along the contour of the ring frame.

In this case, the exemplary embodiment described above may realize joining of the adhesive tape T to the wafer W by suspending functions of the tape cutting mechanism 16 and by placing the ring frame f having the adhesive tape T joined thereto on the frame holder 14 with the transport mechanism.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. Adhesive tape joining apparatus that adhesively holds a semiconductor on a ring frame via a supporting adhesive tape, comprising:
a holding table that holds the semiconductor wafer placed thereon with a pattern surface thereof directed downward;
a frame holder that holds the ring frame placed thereon;
a tape joining mechanism that joins the adhesive tape to the ring frame;
a tape cutting mechanism that cuts the adhesive tape along a contour of the ring frame;
a chamber that is composed of a pair of housings that nips at least the adhesive tape between an outer periphery of the semiconductor wafer and the ring frame for housing the semiconductor wafer; and
a tape joining mechanism that joins the adhesive tape to the rear face of the semiconductor wafer in the chamber under a reduced pressure.

2. The adhesive tape joining apparatus according to claim 1, wherein
the tape joining mechanism functions as an inner pressure controller that controls atmospheric pressure in the chamber; and
the inner pressure controller controls inner pressure in one housing with the semiconductor wafer housed therein as to be lower than that in the other housing for joining the adhesive tape to the semiconductor wafer, both housings being divided with the adhesive tape interposed therebetween.

3. The adhesive tape joining apparatus according to claim 2, wherein
the adhesive tape is joined to the rear face of the semiconductor wafer with the inner pressure controller, and thereafter, atmospheric pressure is made equal in both divided housings, and the housings are opened to the atmosphere simultaneously.

4. The adhesive tape joining apparatus according to claim 1, wherein
the tape joining mechanism comprises:
an inner pressure controller that controls inner pressure of the chamber; and
a joining member that joins the adhesive tape to the semiconductor wafer while moving about a central axis of the semiconductor wafer from a center to the outer periphery of the semiconductor wafer, and vice versa.

5. The adhesive tape joining apparatus according to claim 1, wherein
the tape joining mechanism comprises:
an inner pressure controller that controls inner pressure of the chamber; and
a pressing member that presses an entire surface of the semiconductor wafer radially from the center thereof while being deformed elastically.

6. The adhesive tape joining apparatus according to claim 1, wherein
the semiconductor wafer has an annular projection at the outer periphery on the rear face thereof.

7. An adhesive tape joining method of adhesively holding a semiconductor on a ring frame via a supporting adhesive tape, comprising the steps of:
forming a chamber by nipping at least the adhesive tape between an outer periphery of the semiconductor wafer and the ring frame with a pair of housings; and
joining the adhesive tape to a rear face of the semiconductor wafer with the chamber under a reduced pressure.

8. The adhesive tape joining method according to claim 7, wherein
in the step of joining the adhesive tape, the adhesive tape is arranged close to the semiconductor wafer; and
inner pressure in one housing with the semiconductor wafer housed therein is controlled as to be lower than that in the other housing, both housings being divided with the adhesive tape interposed therebetween, for joining the adhesive tape to the semiconductor wafer.

9. The adhesive tape joining method according to claim 8, wherein
upon completion of the step of joining the adhesive tape, atmospheric pressure is made equal in both divided housings, and thereafter the housings are opened to the atmosphere simultaneously.

10. The adhesive tape joining method according to claim 7, wherein
in the step of joining the adhesive tape, the adhesive tape is arranged close to the semiconductor wafer; and
a pressing member made from an elastic material presses an entire surface of the semiconductor wafer while being elastically deformed radially from the center thereof for joining the adhesive tape to the semiconductor wafer.

11. The adhesive tape joining method according to claim 7, wherein
in the step of joining the adhesive tape, the adhesive tape is arranged close to the semiconductor wafer; and
a joining member turns from the center to the outer periphery of the semiconductor wafer for joining the adhesive tape to the semiconductor wafer.

12. The adhesive tape joining method according to claim 11, wherein
the joining member is a brush that is elastically deformable.

13. The adhesive tape joining method according to claim 7, wherein
the semiconductor wafer has an annular projection at the outer periphery on the rear face thereof
